(19) United States
(12) Patent Application Publication
(10) Pub. No.: US 2010/0328314 A1
(43) Pub. Date: Dec. 30, 2010

(54) Methods, apparatus and system for energy conservation

(75) Inventors: Donald B. Ellingham, Fairfield, CT (US); Richard A. Nichols, Fairfield, CT (US)

Correspondence Address: Donald B. Ellingham, 115 Dwight Street, Fairfield, CT, 06824, US

(73) Assignee: Donald B. Ellingham, Fairfield, CT (US)

(21) Appl. No.: 12/661,594

(22) Filed: Mar. 20, 2010

Related U.S. Application Data
(60) Provisional application No. 61/269,569, filed on Jun. 26, 2009.

(51) Int. Cl. G06T 11/20; A63F 13/00; G06Q 10/00; G06Q 50/00

(52) U.S. Cl. 345/440; 463/31; 705/412

(57) ABSTRACT

Methods, apparatus, and systems are disclosed for monitoring usage of a consumable resource, and displaying substantially instantaneous and historical usage measurements of the consumable resource in both numerical and non-numeric manner. The non-numeric manner facilitates comprehension by non-technical users in conservation applications. The relative size, position and movement of graphical icons, images, symbols and objects convey present and past consumption. A projection of consumption can be calculated and compared against consumption, prompting corrective actions. Past and present conservation performance can be displayed in the context of a game. Various symbols optionally incrementally visually reward conservation or admonish failure, and therein score efforts. Challenging goals can be established to increase conservation. User-chosen display color schemes facilitate décor integration. Integration of the display into various devices including gas or liquid flow-control valves, and electrical dimmers and switches are disclosed. A portable version facilitates resource waste detection and problem location.

### CROSS REFERENCE TO RELATED APPLICATIONS

This application claims the benefit of U.S. Provisional Application No. 61/269,569, filed Jun. 26, 2009, incorporated by reference herein.

### FIELD OF THE INVENTION

The present invention is related to the field of energy conservation and, more particularly, to aiding individuals in the conservation of energy.

### BACKGROUND OF THE INVENTION

Energy conservation is a growing global goal as the true cost of energy, whether monetary or in terms of environmental impact, is recognized. Electricity is primarily generated by sources that are known to have an environmental impact, including various fossil fuels, and nuclear power. Research shows that all forms of energy production or capture have some negative impact on the planet. Seemingly benign hydroelectric power generation requires dams that often alter the environment and threaten aquatic wildlife such as migrating andromonous species of fish. Wind turbines to some are a form of visual pollution and can have a negative impact on flying species such as birds and bats. Both solar panels and wind turbines require the burning of fossil fuels and/or the use of toxic materials in their manufacture. Thus, even though a seemingly environmentally friendly technology appears to reduce the “carbon footprint” or planetary impact, energy conservation will reduce the need for all of these sources, and be a key and desired goal on a global scale.

Electricity is distributed and sometimes actually generated by an electric utility company and, in some instances, generated locally at a home or business. The electric utility company measures the electrical usage, usually in kilowatt-hours, on a meter external to the dwelling or business. This provides unimpeded access to reading the meter without having to gain access to the building and, increasingly, is read remotely using a communication link. The customer is only made aware of their electrical energy usage through their monthly utility bill. The utility bill typically provides only an indication of the total energy usage for the month. Since the bill is provided only once a month, there is no recognizable connection between individual energy consuming activities and the amount of energy for the activity. There is no hourly or even daily accounting of the energy usage or source of the usage. Thus, a consumer of energy is unaware of the true energy cost of a particular activity and does not possess the knowledge or skills to effectively conserve energy.

The past 20 or more years have seen the advent of numerous commercial products that claim to “save energy”. In fact, many are mostly either ineffective devices or tools to assist the user in merely quantifying the energy used at any given moment, in an indoor instrument. This is similar to the outdoor meter the Power Company reads monthly, though the numbers are usually presented in a more-readable numerical form. Still, many of these conventional indoor meters have little meaning to the average consumer. The user discovers they have used 569 kilowatt-hours (kWh) this month, but may not remember what was used last month. If the device provides this history, what does it mean? What caused this amount of energy to be used? How does it compare to previous months or the same month last year? Are a user's efforts actually improving their carbon footprint? What device or activity is consuming the most energy? This information is not typically available in a conventional conservation device or in a form that is suitable for use by a non-technical consumer.

The EIG Shark 100-S manufactured by Electro Industries/GaugeTech is a commercial grade, indoor remote reading power meter with a numerical display. The Wattson, made in the United Kingdom by DIY KYOTO, is a numerical display for which you can purchase PC-based bar-graph display software.

In addition, some devices tabulate the power used over a period of time and others, with the assistance of manually entered electric utility bill values, attempt to assign a dollar value to the electricity being used. Some exemplary devices are the “Power Cost Monitor” manufactured by BlueLine Innovations Inc., “The Energy Detective” by Energy Inc., the “EML 2020-H Home Energy Monitor” by Brultech Research Inc., and the “Cent-a-Meter” by Eco-Response Technologies Inc. It is important to point out that most, if not all of these devices display numerical data only. Some have optional, separately connectable computer means to allow technical analysis, but again, it is not evident that this actively engages the user in the conservation process.

The following illustrates the difficulty in computing cost in a practical manner. Electric utility bills contain an itemized series of complex calculations with such factors as a basic service charge, on-peak and off-peak kWh (power) consumed and their respective costs, separate distribution and transmission fees per kWh, fuel adjustment fees and taxes. Many bills include items like bypassable FMCC, a systems benefit charge, a competitive transition assessment per kWh, a conservation & load management program fee, and a renewable energy investment fee. While some of these may be due to the desirable trend of purchasing “green energy”, they must be accommodated and accounted for.

Even a technically inclined person would have to carefully read the fine print on the back of such a bill for explanations to understand the bill, the ever-changing additional fees, and the actual energy usage. The prior art also provides little or no means to easily enter the information and cost parameters into the conventional “cost-calculating displays”. Often, only a few buttons are available to step through data-entry menus with a process that is frustrating for the user. Other conventional devices provide for a connection to a PC with a special cable in order to program the device.

Another problem arises in grid-connected energy producing customers with renewable resources of their own. Sites with solar photovoltaic panels or wind turbines are not accommodated by many of these devices. There is no provision for “net-metering”, i.e., metering which tracks electricity provided by an electric utility as well as electricity generated locally and provided back to the electric utility.

A need therefore exists for a method, system and apparatus that enables a user to track energy consumption and effectively monitor energy conservation.

### SUMMARY OF THE INVENTION

Generally, methods, apparatus, and systems are disclosed for monitoring energy usage, comprising the steps of obtaining measurements of energy usage; and determining a first graphical representation of the energy usage measurements. The first graphical representation may be displayed and may comprise a symbol that represents an average of one or more measurements of energy usage. In one exemplary embodiment, the average is an average of the energy usage consumed on two or more days of one or more previous weeks.

In another exemplary embodiment, a substantially instantaneous measurement of energy usage is obtained; and a graphical representation of the substantially instantaneous measurement is determined. The graphical representation of the substantially instantaneous measurement may be displayed and, in one exemplary embodiment, a size of the instantaneous graphical representation is proportional to the substantially instantaneous measurement.

In another exemplary embodiment, a projection of energy usage is computed based on stored energy usage measurements and the display location of the instantaneous graphical representation represents the projected measurement of energy usage for a selected time period.

In one exemplary embodiment, the graphical representations can be determined by a user. For example, the graphical representation, can be selected by a user, or designed by a user.

A measurement associated with a graphical representation can be indicated by a shape or color of the graphical representation, or by a quantity of symbols utilized in the graphical representation. In one exemplary embodiment, the graphical representation comprises a bar-graph, wherein each of the bars in the bar-graph represents a type of energy usage for a specified time period. An arrow at a top of a bar in the bar-graph can indicate that an energy usage measurement is increasing or decreasing.

A more complete understanding of the disclosed invention, including further features and advantages, will be obtained by reference to the following detailed description and drawings.

### BRIEF DESCRIPTION OF THE DRAWINGS

FIG. 1 is a display screen image of an exemplary embodiment of a display for displaying energy usage and energy conservation information to a user incorporating features of the present invention;

FIG. 2 illustrates a standard switch-plate of a contemporary design incorporating features of the present invention;

FIGS. 3-6 provide further examples of the graphics of a display screen incorporating features of the present invention;

FIG. 7 is a drawing of an LCD or OLED display integrated with a conventional switch or dimmer functionality in a switch plate mounted on a wall;

FIGS. 8 and 9 illustrate the block diagrams of a first exemplary embodiment of the base system and a first exemplary embodiment of the remote display system, respectively;

FIG. 10 is a block diagram illustrating an integrated implementation of an exemplary base system and display system; and

FIG. 11 is a flowchart illustrating a method for monitoring and displaying energy usage in an eco-gaming environment;

FIG. 12 is a Cartesian graphical representation of the numerical values stored in a portion of the linear memory; and

FIG. 13 is a table describing an exemplary method for selecting days of historical data that are of relevance to the current day for use in evaluating conservation effectiveness.

### DETAILED DESCRIPTION

Many conventional energy conservation devices have flaws in their presentation and analysis concepts; perhaps the most prevalent flaw is that most are of little value to a person with no related technical training. This very challenge, creating a useful, easily understood display of current and past electrical energy usage, monitoring conservation trends against certain collected history and presenting the compiled information in a way that draws the consumer into “the game” of energy conservation, is a primary focus of the disclosed invention. Graphics chosen for psychological effect are one element at the core of the means to this end. As mentioned, while most of the previously mentioned devices do not have graphical displays, a few have options for graphical representations of the data on a connected computer. It is a primary function of the current invention to make the graphical display easily accessible and, in one embodiment, to make it an integral part of the energy conservation device.

Individuals may not currently be proficient at energy conservation, but there is a whole generation of “baby-boomers” who have grown up with video games, starting with Atari's “Pong”, first seen in arcade form in 1972, that have spent hundreds of hours challenged by a huge variety of video games. So engrossing are these games that this became a 9.5 billion-dollar industry in the USA in 2007. Players of these games tend to respond to graphical challenges. It is with this knowledge of the motivational aspects of game playing and the growing global concerns about the effects of energy consumption on the environment that the present invention seeks to make the “game” of conservation an engrossing challenge, with ever-increasing benefits.

The disclosed system creates an environment where the user continuously competes with himself to improve their energy conservation performance, creating an “eco-gaming” (energy conservation gaming) environment. As the conservation performance gets better, a user competes against past performance with the projected data constantly providing an estimate of the user's path so that the user can correct any inefficiency or waste of energy.

The eco-gaming environment may also be expanded to allow users to compete in a multi-player game of energy conservation, where one player's performance is compared to one or more other players in a competitive game.

Generally, methods, apparatus, and systems are provided to cause modification of user behavior in daily energy use. The disclosed methods utilize techniques that sensitize a person to the magnitude of energy being used at any given moment (instantaneous) or over selectable periods of time, in a manner such that they are subtly and continually aware of the energy usage, and self-motivated to reduce their overall energy consumption. It is proposed that energy conservation facilitated through self-motivation is likely to be quickly apparent in one's energy bills, providing further motivation for additional, continued energy reduction. The disclosed methods, apparatus, and systems are suitable for residential applications and are scalable to an apartment, office complex, campus, university and industrial application.

In one aspect of the invention, an energy conservation-inducing display is utilized to cause personal behavior modification in daily energy usage. The display may be customized and is suitable for both technical and non-technical individuals. In an exemplary embodiment, multiple remote displays are used and located at multiple locations where they may be beneficial, such as at points of heavy power consumption or environmental control or at the entrance or control center of a building.

One additional benefit of the present invention is the additional savings in heating or cooling energy costs. If the home is heated electrically or by heat pumps, the connection to cost savings is obvious, but even with oil or natural gas as the fuel, savings are accumulated through reduced use of the furnace, blowers and pumps associated with the heating system. More importantly, the fuel itself is conserved through the reduced runtime of the furnaces. So, as additional benefits of the proposed invention, the user saves costly fuel used in maintaining their living or working environment and reduces the carbon load on the environment.

The disclosed system includes options for displaying various text and/or graphics, described below, which affect different emotional aspects of the person's overall energy concerns. The graphics may be disguised in an artistic display to convey the information required to induce the personal behavior modification and to provide a gaming environment or gaming feedback (described below). In an exemplary embodiment, the energy usage is displayed using one or more of graphics, icons and symbology that are representative of the relative cost or environmental impact of the energy usage and on the performance of energy conservation. The symbology is designed in a custom or semi-custom manner for various individuals or groups of individuals. For example, the symbology can be designed to be understood by all members of a family such that the symbols have similar emotional effects on all family members and promote cooperative conservation.

In another aspect of the invention, the energy conservation process is implemented in a game in which a user is competing against himself, or cooperatively as a family against itself, by comparing a current performance of energy conservation with a past performance of the energy conservation. The gaming aspect may be conscious, or may simply be a subconscious manifestation of a game. In addition, the gaming may compare the user's energy usage with benchmark data corresponding to a typical or ideal energy usage.

In a preferred embodiment, several display options are selectively available. In one exemplary embodiment, the overall disguise of the display could be that of an electronic picture in a frame of any size. In this embodiment, the user can switch between various display modes, including variants of the disclosed symbolic form, fully technical power-use over time studies or related local weather and its forecast or “degree-days” in several operator-interactive ways. Touching the screen or frame and activating enclosed capacitive or resistive sensors can be used to activate various features. Detecting human presence nearby through the use of one or more optical or thermopile infrared body-heat detectors in specific related orientations, can allow for the selection of many different functions through a library of hand gestures. After a predefined period of time, the frame display can switch back to an electronic picture in a frame (a sort of screen-saver) to lessen the “in-your-face” aspect of the conservation function.

In another exemplary embodiment, a second display comprises “contemporary art” where complex relevant energy trend information can be conveyed in a comparatively simple display. This is achieved through the placement, shape and/or color of one or more geometric shapes (such as lines, circles, triangles and any other closed shape) on the display surface. The color and physical relationship between each shape and the boundaries of the display surface or other shapes, can be a fluid, data-dependant arrangement. Because the power being consumed in a home, for example, is a function of the occupants' activities and the collection of manually operated, self-cycling, and weather and time-of-day influenced equipment, the display will take on the dynamic nature of the changes in energy usage and conservation as they occur. The home, and therefore the display, become almost a living organism, and the user is almost unavoidably drawn to its continual variations. The data is no longer some arcane list of numbers; it is now a responsive, attractive graphic wherein the user's activities influence the display and provide a far more effective device for involving the user in the game of conservation.

Furthermore, in addition to some pre-selected options for display, it is disclosed that the user can have an option to create his or her own contemporary art, from a selection of shapes and colors on a set-up menu, that represent the energy consumption and energy conservation. The user could influence the content and it's motion. In another exemplary embodiment, the user can select from a menu of colors to match a particular décor, facilitating tasteful integration of an otherwise technical device into the user's environment. More organic shapes, such as those in a lava lamp, or occurring in nature, such as fractal growth patterns in a fern plant, are possible. In this case, the application of the device is disguised while still encouraging progressively better energy conservation habits.

Alternatively, an industrial application may have no such need for aesthetics; its symbology would be entirely functional and yet still employ the motivational aspects of the invention to encourage energy conservation by comparing current energy usage trends to historical energy usage trends while challenging the user to make continued improvement.

In another aspect of the invention, a portable display is disclosed that has an “energy sleuth” mode with increased or exaggerated differential sensitivity. The portable device doubles as a means for waste detection and location. The display is carried and viewed as various power-consuming devices are powered on and off. As each device is powered on and/or off, the associated energy consumption of the device is detected, registered and displayed in either a symbolic or a technical manner. The information regarding the energy consumption of each device is then subsequently used to recognize devices that are particularly wasteful or frivolous and influence the judicial use of those devices.

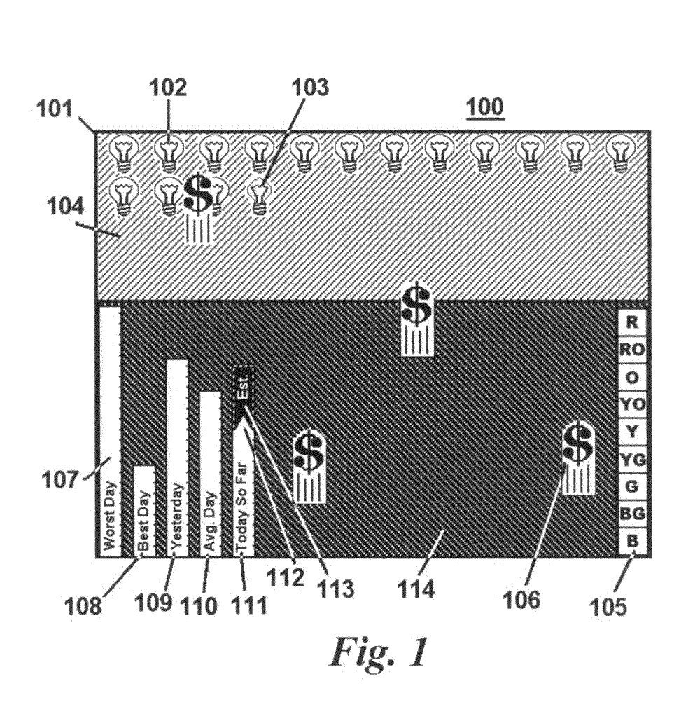

FIG. 1 is a display screen image of an exemplary embodiment of a display 100 for displaying energy usage and energy conservation information to a user incorporating features of the present invention. Without the use of numbers, it conveys considerable relative and numerically symbolic information. Display 100 comprises a display screen 101. In one exemplary embodiment, display screen 101 contains 320×240 pixels and demonstrates that sufficient basic graphical information can be displayed on a relatively small, inconspicuous and inexpensive LCD-type display. All information displayed on display screen 101 is scalable to larger or smaller displays and can be combined with other pertinent data such as weather (past, current or future), security system status or various alert messages. Display screen 101 can display 48 light bulb icons 102, where each light bulb icon 102 represents one kilowatt of load. Thus, display 102 can indicate a load of from 1 to 48 kW (where 48 kW is equivalent to a 200 Amp home electrical service capacity). In alternative embodiments, a greater or lesser number of light bulb icons 102 can be utilized to enable a larger or smaller home electrical service capacity; alternatively, each light bulb may represent a greater or smaller load. In addition, a smaller light bulb 103 may be used to indicate a fraction of 1000 watts. For example, smaller light bulb 103 may represent 700 Watts. The total displayed current represented on display screen 102 is (15×1.0 kW)+0.7 kW or 15.7 kW. The green background 104 (shown as diagonal stripes) indicates the projection that the energy usage is estimated to be better today than another day, e.g. yesterday. The varying background color (shown as white dots on a black background) can follow a color scale (ranging, for example, from R=Red, RO=Red/Orange, O=Orange, YO=Yellow/Orange, Y=Yellow, YG=Yellow/Green, G=Green, BG=Blue/Green, to B=Blue) such as the one at the lower right 105 conveying to a user if the current trend of energy conservation is better (less energy consumed and more toward the blue end of the scale) or worse (more energy consumed and more toward red). By using icons of various sizes, the display information can be designed to allow a user to recognize the displayed information from a distance.

In the exemplary embodiment shown in FIG. 1, display screen 101 is overlaid with animated, flying-away red dollar signs 106, shown in FIG. 1 as black on white for clarity. Dollar signs 106 begin at random locations off of the bottom of the screen, moving up and over the top of all other display elements, with an appearance frequency roughly proportional with the power usage as represented in the number of light bulbs above. The dollar signs 106 and light bulbs 102 may use simple sprite-animation techniques and demonstrate the level of consumption.

The lower half of display screen 101 displays statistical information representing energy usage and energy conservation performance in bar-graph form corresponding with the worst day 107, best day 108, previous day 109, average day 110 and present day 111. The arrow 112 at the top of the today bar indicates energy usage is still climbing and the yellow outline 113 (shown as solid black) indicates the estimated total energy usage for the present day. The remaining black area 114 (shown as white dots on a black background) can be used for other statistical data, left black or contain other important system information.

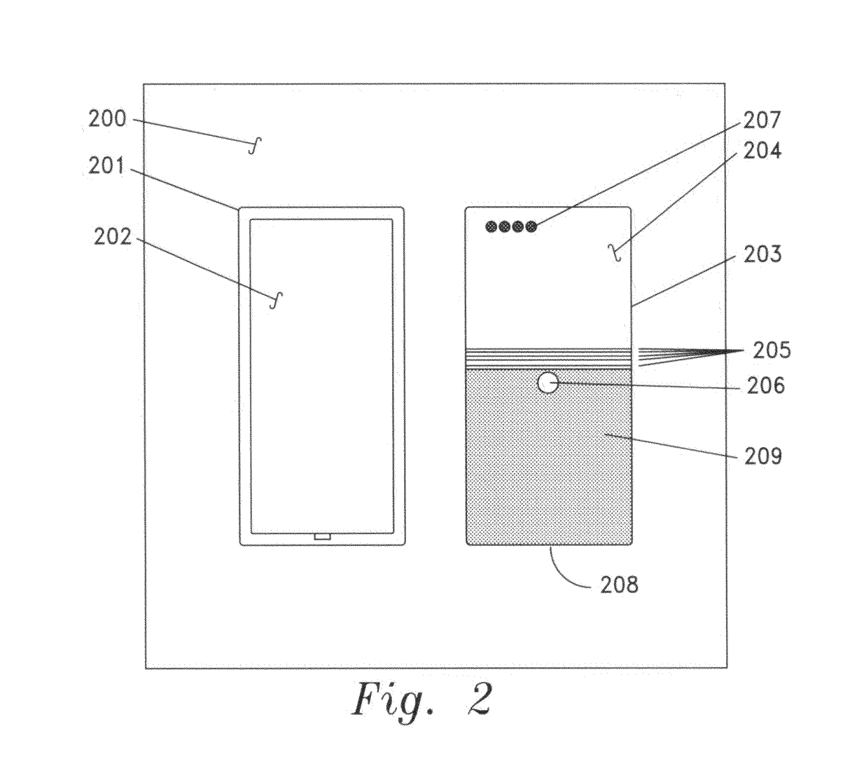

FIG. 2 illustrates a standard switch-plate 200 of a contemporary design incorporating features of the present invention. Standard switch-plate 200 serves as the decorative fascia for conventional electrical switches and outlets, such as dimmer switch 201 (of the “Decora®” style, manufactured by the Leviton Company of Little Neck, N.Y.) which contains a touch activation surface 202. Other various switches and controls are available for these large-opening switch plates and the large opening is particularly suited to the incorporation into these plates of an embodiment of the invention. While a very small display could be created in the opening of a “standard” toggle type switch plate or the display could reside on the outer surface with a connection through the small opening, it is functionally useful that the opening in the switch plate is large enough for a display to reside within it. In one exemplary embodiment, display 203 is mechanically mounted within standard switch-plate 200 of a contemporary design in a manner similar to conventional dimmer switch 201.

Display 203 is mounted into the secondary opening of standard switch-plate 200. The actual face 204 of display screen 203 displays the graphical display. Horizontal lines 205 are displaced from the bottom of the face 208 by an amount representative of the power used at the end of each of several past time periods, e.g., the end of each of the past several days, that correspond to a present time period, e.g., the present day. For example, if the present day is Monday, each of the horizontal lines 205 is displaced from the bottom of the face 208 by an amount representative of the total power used during respective earlier Mondays. Each previous day may be offset in time by a week, month or a year, depending on the amount of history accumulated by the system. The horizontal lines 205 thus provide an indication of the range of power used on similar days. In addition, a dot 206 is displaced from the bottom of the face 208 by an amount representative of the total power projected to be used during the present day.

In the event that today's average, as indicated by the displacement of the dot 206, is centered below the average of some or all of the horizontal lines 205 by a predefined percentage, then feedback symbols 207, stars or other graphic icons are awarded and displayed near the top of face 204. The feedback symbols 207 may be awarded in proportion to the ratio of the displacement of the dot 206 to the displacement of a horizontal line 205 (or the average displacement of two or more horizontal lines). For example, the feedback symbols 207 may be added at the rate of one per unit percentage, such as one feedback symbol 207 per 0.5 percent or one feedback symbol 207 per one percent of projected savings for the present day. The feedback symbol 207 represents feedback on the energy conservation performance of the user and will serve to stimulate a gaming response in the user. The feedback symbol 207 shows the users and other observers how the user is doing in the effort to conserve energy. Further, operation of the adjacent dimmer switch 201 will influence the trend as indicated in the display 203. Those skilled in the art would recognize that display 203 may optionally include the use of color in the display, backlighting and touch activation of other graphical display types and access to a text or graphical menu for setup of the device display and operation. In addition, a user may select display colors to match a particular room décor. The exemplary embodiment of display 203 illustrated in FIG. 2 is primarily an indicator of relative numerical value, with the vertical span encompassing at least the currently used portion of the range of power delivered to the structure being monitored. A typical home may have a 200 Amp electrical service at 240 VAC allowing up to 48,000 watts of maximum load. The total energy available is 1152 kWH in a 24 hour period. In that case, some portion of, and possibly all of the full-scale range of the dot and lines to be discussed is included within this display area. Exaggeration or scaling of this range and the performance of energy conservation is possible by only displaying part of the total range or using a non-linear vertical scale. Time may also be indicated by displaying an image of relative usage history, animated off ideally to the left but possibly in any direction, i.e., by displaying one portion or window of a strip chart. This is similar to paper-strip displays commonly used in electrocardiograph heart monitors, seismographic earthquake and temperature or barometric pressure recorders, all of which demonstrate an analog function recorded over time, which typically is the x-axis of the recording or display. Contemporary strip chart recorders often do not use consumable paper, but use computer or other electronic screens. These displays are well known to all practicing in the scientific and academic communities.

Discrete graphical symbols, e.g., feedback symbols 207, can be used to indicate the energy usage and performance of energy conservation data, such are often used in liquid crystal consumer displays. These fixed-symbol displays are very low cost and require very simple drive electronics and often have only many tens of symbols (or less) for the electronics to control. As depicted in FIG. 2, a fully addressable x,y dot matrix display is more flexible, allowing a wide range of graphics which are both user selectable and future upgradeable. In this exemplary embodiment, certain graphic elements are assigned to represent various aspects of energy consumption. A black area 209 (shown as black dots on a white background) filled in below the lowest of the horizontal lines 205 represent the minimum energy typically used and creates a contrasting area for the lower part of the image on face 204. A dot 206 indicates, by the magnitude of its diameter, the specific power being used at the present instant. As indicated earlier, the vertical position of the center of the dot 206 is indicative of the average power expected by the end of the present day. This is projected by the method as further described in conjunction with FIG. 12.

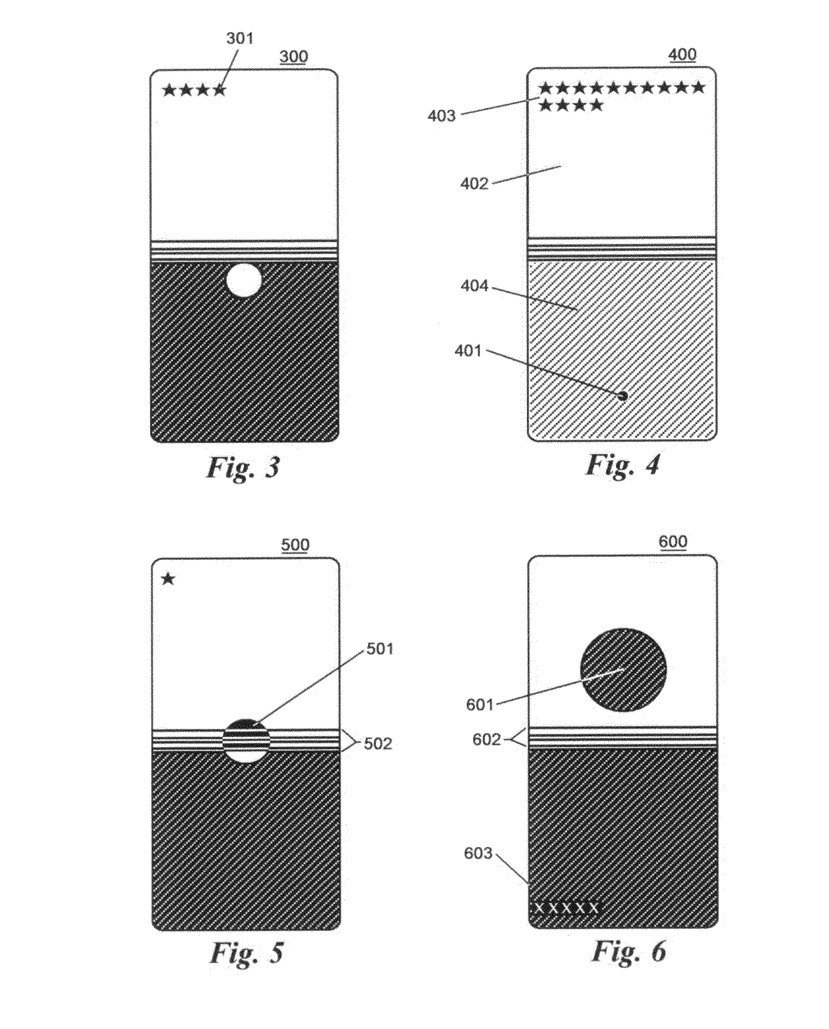

FIGS. 3-6 provide further examples of the graphics of display screen 203. In FIG. 3, the dots 207 of FIG. 2 are replaced by the stars 301 in the graphic display 300. Stars 301 are a more appropriate and self-explanatory reward for conservation than dots 207 (as shown in FIG. 2); however, stars 301 may be less appealing in certain environments.

FIG. 4 depicts a bi-color, electronic ink or any type of liquid crystal display 400 with a fixed color-pair. In the exemplary embodiment of FIG. 4, “color A” (shown as a white background) 402 and “color B” (shown as diagonal rows of black dots on a white background) 404 are used for high contrast in situations not requiring a backlight. Shown is a day with particularly low projected energy usage as indicated by the low position of the dot 401. Currently, the very small diameter of the dot 401 is also indicating very low energy consumption at this moment in time. The large number of stars 403 at the top of display 400, project substantial energy conservation for the day.

FIG. 5 shows, by the position and size of the dot 501 on display 500, that the projected energy usage is just barely better than the average of the past days. Notice that dot 501 is drawn using the exclusive-OR drawing logic, i.e., all picture elements, or pixels (in this case horizontal history lines 502) overlaid by the dot are inverted in state, with black becoming white and white becoming black. This is not a required element, but is one of the options in graphical drawing-logic and allows the black lines that otherwise would have been obscured by the black dot, to be seen. This is useful in the embodiment of FIG. 5 because the relative position of the dot 501 and the lines 502 have technical significance. Objects on the display may overlap, hide behind each other or affect each other in any manner, or may change shape or “morph” into other objects during the representation of the energy conservation (achieved in the past or expected in the future).

FIG. 6 depicts a point in time where the instantaneous current energy usage is very high, indicated by the large size of the dot 601; its location above the history lines 602 in the display 600 predicts much higher usage than usual. This results in a penalty represented by the X's 603 which could be any other shape, e.g., a symbol representing percent units worse or “carbon footprint units”.

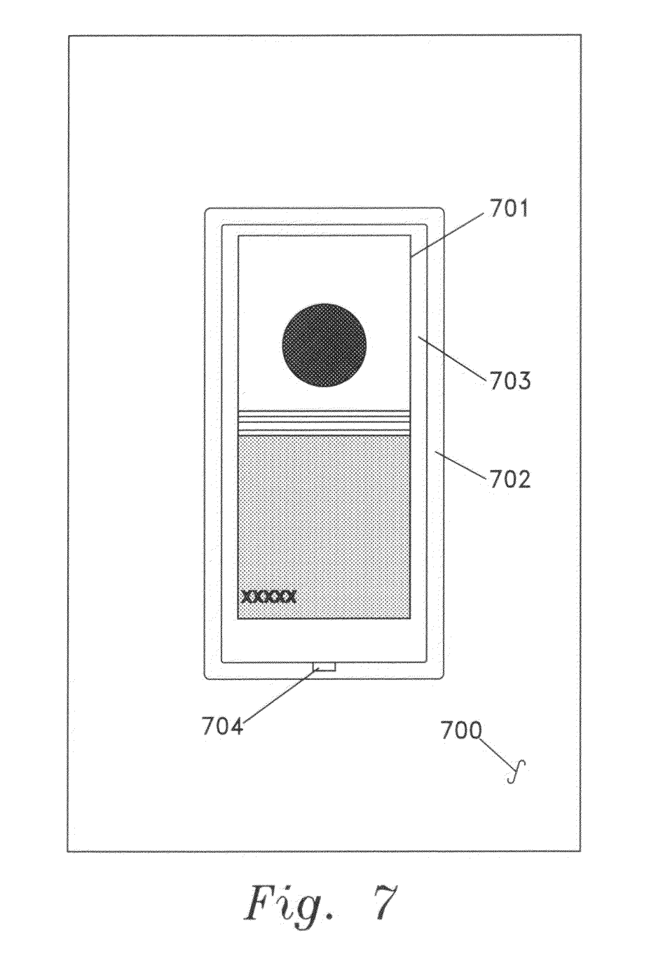

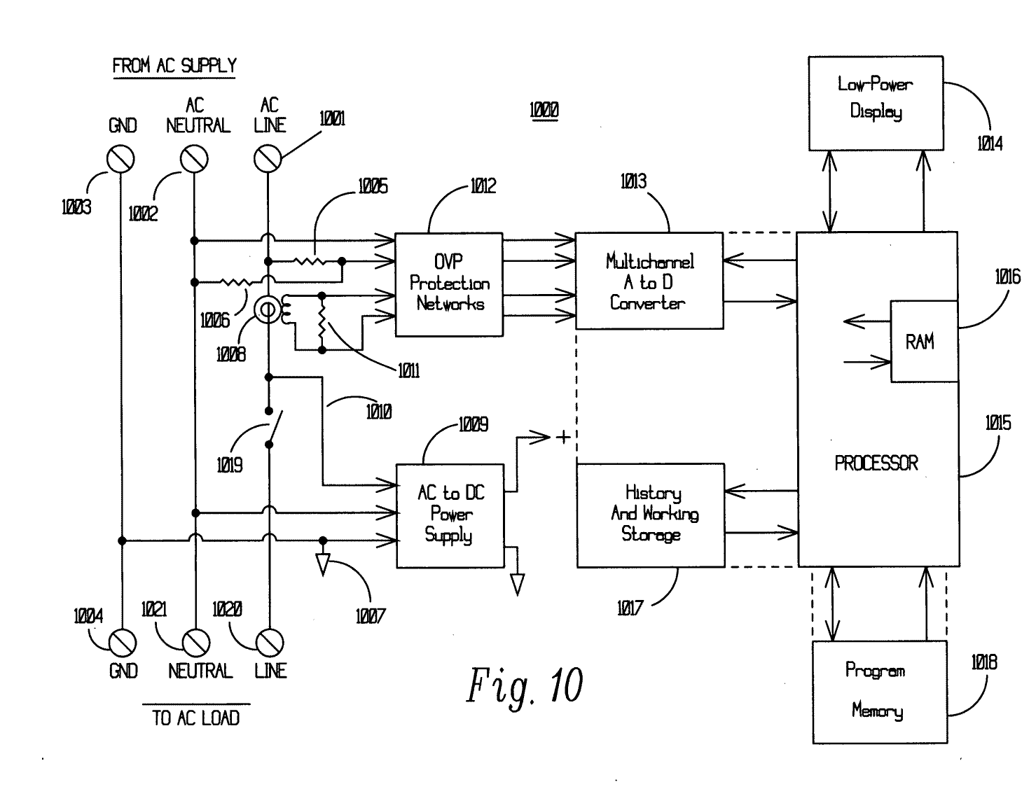

FIG. 7 is a drawing of an LCD or OLED display 701 integrated with a conventional switch or dimmer functionality in a switch plate 700 mounted on a wall. LCD or OLED display 701 might control a single circuit passing through it by dimming, switching, timing or activating via an internal or remote clock or remote control signal, and also display usage and conservation gaming results (as described above). LCD or OLED display 701 may be used for the lighting of a single floor in an office building, landscape lighting on an estate, controlling a heater on a whirlpool bath or in a sauna, or controlling a filter on a swimming pool. The display 701 can be incorporated into a single-device switch plate 700 with a bezel 703 surrounding the periphery of the display 701 and covering its edges and interconnections to the included internal electronics of display 701. If the display is an unlighted type as shown earlier in FIG. 4, indicator 704 can be included to indicate if the circuit is active. If lighted, the display could increase in brightness or employ some other on-screen graphical symbol for circuit activity, dimming level and time left for timing applications. A circuit capable of implementing LCD or OLED display 701, not including indicator 704, is shown in the block diagram of FIG. 10.

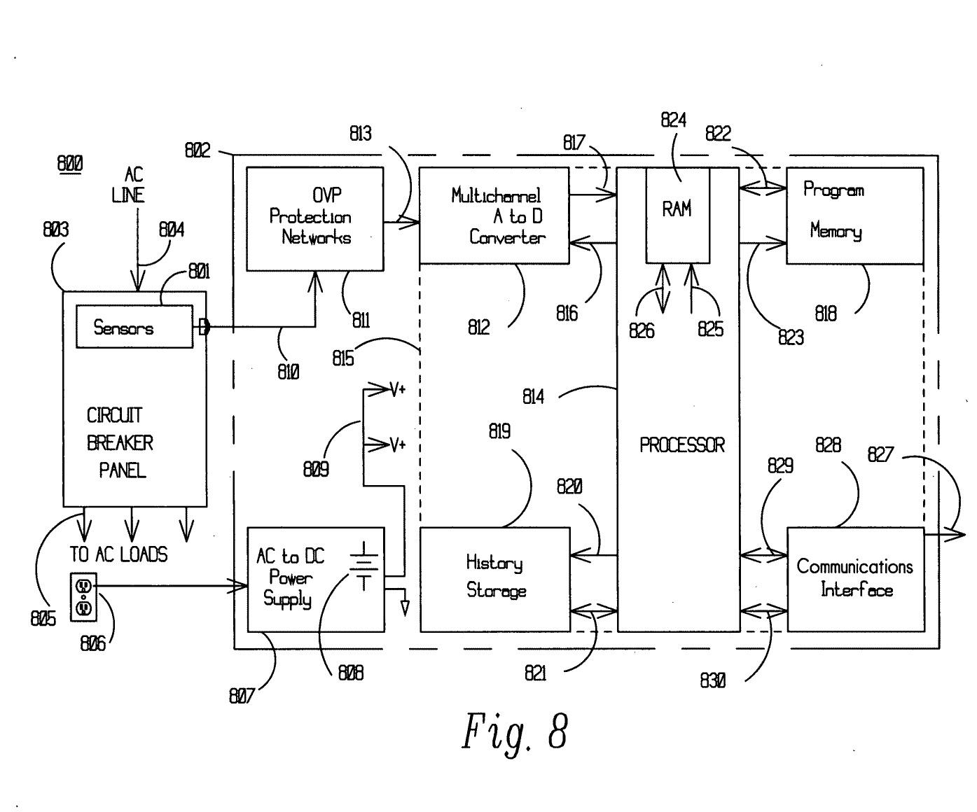

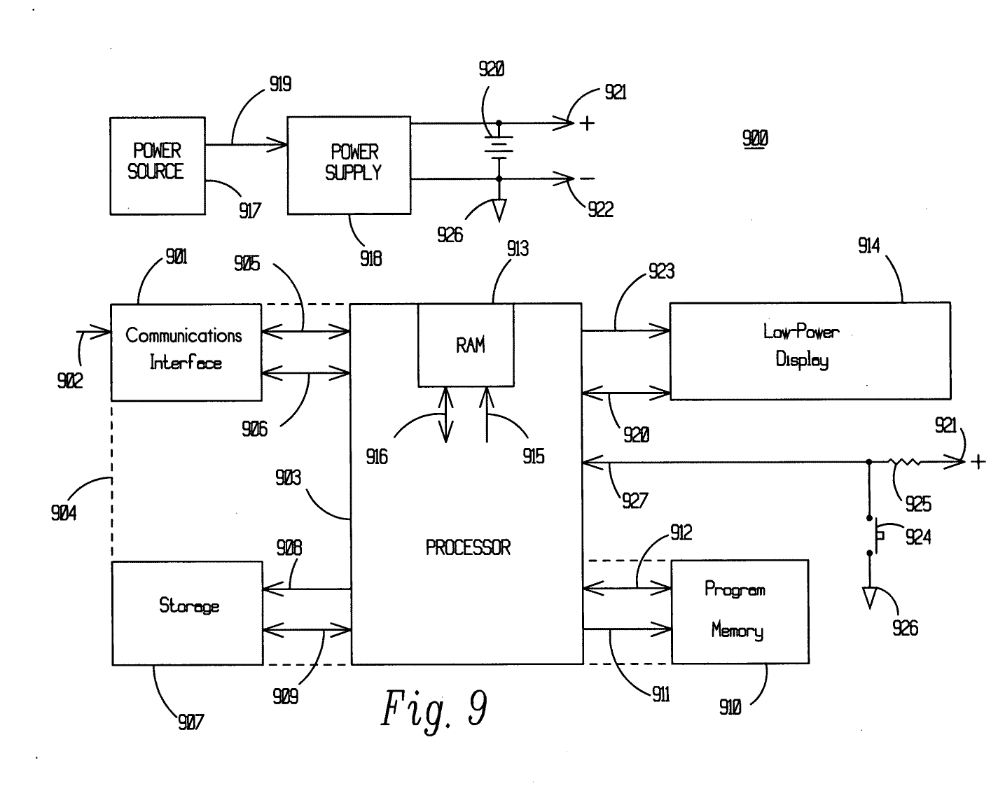

FIGS. 8 and 9 illustrate the block diagrams of a first exemplary embodiment of the base system 800 and a first exemplary embodiment of the remote display system 900, respectively. FIG. 10 further illustrates a block diagram of a second exemplary embodiment of a combined base and remote display system as described in FIG. 7.

FIG. 8 illustrates a block diagram of a base system 800, including a set of connected AC current and voltage sensors 801 and processor circuit 802. Conventional circuit breaker power distribution panel 803 provides an interface to AC power line 804. The AC power line 804 enters the circuit breaker power distribution panel 803 following the power company meter (not shown). AC current and voltage sensors 801 monitor energy usage passing through the circuit breaker power distribution panel 803. The typical components of the sensors duplicated for each AC phase are detailed later in FIG. 10, for current 1008 and 1011 and for voltage 1005 and 1006. AC current and voltage sensors 801 may alternatively be incorporated into the manufactured circuit breaker power distribution panel 803, or a circuit breaker power distribution panel 803 may be retrofitted with AC current and voltage sensors 801 as part of an after-market add-on conservation monitor. In one exemplary embodiment, AC current and voltage sensors 801 may be current-transformers, and one AC current transformer may be used for each phase of the incoming power line 804. In addition, there are also differential voltage connections to each phase of the line voltage and neutral. Each line voltage sensor contains a resistor L-configured divider, as is customarily used, to divide the conventional 120 VAC per phase line voltage, by a factor chosen to limit expected maximums to within the digitizing range of the multi-channel Analog-to-Digital converter 812, so no high voltage excursion data is lost. Alternatively, AC current and voltage sensors 801 may be utilized to measure a current on a subset of phases or circuits within the panel.

Individual AC branch circuits 805 distribute power from the circuit breakers (not shown) located within the circuit breaker power distribution panel 803 to locations throughout a residence or building in a known manner. For example, AC branch circuit 805 provides power to a local AC outlet 806, into which an AC to DC power supply 807 (that supplies DC power for the base system 802) is plugged. In one exemplary embodiment, a long-life lithium primary or secondary, or equivalent, cell or battery 808, would provide DC power back-up for the base system 802 and may be located internal to the power supply 807 or at any location near the DC power distribution 809. In the event of a power interruption, the battery 808 would at least provide power for an orderly shutdown and re-start (at power return). The battery 808 could also continue to supply power for the base unit 802 to log power line conditions during the failure. This is especially useful in brownout situations of reduced line voltage. An optional super-capacitor (not shown) can provide hold-up of the DC output while replacing this battery.

Differential sensor wires 810 from the AC current and voltage sensors 801 feed OVP protection networks 811. OVP protection networks 811 can contain back-to-back zener diodes, metal oxide varistors or similar energy-limiting devices across each pair of differential sensor wires 810. OVP protection networks 811 provide over-voltage protection from line-fault or lightning-induced voltage spikes. Note that there are limits to the extremes that OVP protection networks of this type can protect against. The various commercial protection devices are usually rated in Joules, which they can absorb before failure, and handle all but the kind of enormous surge that would destroy many line-connected appliances. Also included is a load or burden resistor, only required for each current transformer driven twisted pair. It provides a current load for the current sensor, and the resulting differential voltage is sent to the multi-channel Analog-to-Digital converter 812, along with the additionally protected pairs of differential voltage sensor wires.

The output differential voltages 813 are converted by multi-channel Analog-to-Digital converter 812 into digital current and voltage data for the processor 814. Multi-channel Analog-to-Digital converter 812 may be separate from, or an integral part of the processor 814, as indicated by the dashed inclusion lines 815. Address and control lines 816 from the processor 814 manage the multi-channel Analog-to-Digital converter 812 conversion process, and data sending processes. The converted data 817 from the multi-channel Analog-to-Digital converter 812 connects to some of the data inputs of the processor 814 for processing by the program running the processor 814. The “processor” is a term used to cover a microprocessor, micro-controller, programmable gate array, programmable logic device, sequencer, or any electronic means for controlling the sequencing of data collection and either local processing or immediate transmission from a point anywhere in the data processing stream, to the remote display 914 in FIG. 9.

It is obvious to one skilled in the art that the process of computing the data to be displayed, once collected at the base system 800, can be performed in the base system 800, or in the display assembly 900. Additionally, computation on collected data can be divided at any point in the computation process, between the base system 800 and the display assembly 900. In this first example, some level of processing is possible in the base system 800, including data sampling at a rate of at least several samples per AC cycle, preferably tens of samples, to accommodate current waveform distortion and accurate RMS conversion, which is done by the processor 814. After conversion, data can be analyzed and temporarily stored in the RAM 824 and sent to the display assembly 900 for display at high-resolution, and also be reduced by the processor to a lower temporal resolution for later use as historical data in computation and display.

A separate history storage unit 819 can be used for long-term, non-volatile storage to conserve power. The history storage unit 819 may be FLASH memory or other memory devices and may be integrated into processor 814. Because of the limited re-writeability of a FLASH memory, alternative exemplary embodiments append the stored data and do not frequently, or perhaps ever, re-write data once stored. This assures a long operating life for the history storage unit 819 if FLASH RAM is employed. Since the historical data may be very valuable for proper operation of the system, a duplicate back-up FLASH or secondary area thereof may also be implemented in a known manner. Likewise, the addition of checksums, and error detection and correction hardware or software may be utilized to insure historical data integrity, as are common elsewhere in the computer and microprocessor fields.

Address and control lines 820 connect the processor 814 to the history storage unit 819 in a known manner. Data I/O lines 821 connect the processor 814 to/from the history storage unit 819 and can be separate, bi-directional, can be combined with address and control lines 820 in serial or parallel data streams, or can be totally internal to a combined history storage unit 819 and processor 814, as indicated by the dashed inclusion lines 815.

Program Memory 818 stores the program code executed by processor 814. Address and control lines 823 connect the processor 814 to the program memory 818 in a known manner. Data I/O lines 822 connect the processor 814 to/from the program memory 818 and can be separate, bi-directional, can be combined with the address and control lines 823 in serial or parallel data streams, or can be totally internal to a combined program memory 818 and processor 814, as indicated by the dashed inclusion lines 815. Program memory 818 can be RAM, ROM, EPROM, FLASH, any other type of one-time programmable, re-programmable or random-access memory, or a combination of the foregoing. In one exemplary embodiment, a power backup mechanism is utilized in a known manner. In addition, conventional microprocessor systems may optionally store the program code in FLASH memory and, on power-up or re-boot, transfer the program code to RAM, e.g., RAM 824, where it can run at a faster RAM speed. Any of these and other schemes and all others practiced by those skilled in the art can be used. Data stored in the program memory 818 is usually only read by the processor 814, but also can be written during software loading prior to shipment, as shall be explained below, allowing the latest revision of executable code to be shipped, or later changed during subsequent field upgrades at a later date.

RAM 824 can be an element of the processor 814, as indicated by the dashed inclusion lines 815; alternatively, it can be external to the processor 814, or expanded externally. Working data and intermediate results of calculations are usually stored in RAM 824. In some implementations, data from numerous measurements can be temporarily stored in RAM 824 for a bulk data write to the history storage 819 at a convenient time.

Address and control lines 825 connect the processor 814 to the RAM 824 in a known manner. Data I/O lines 826 connect the processor 814 to/from the RAM 824 and can be separate, bi-directional, can be combined with the address and control lines 825 in serial or parallel data streams, or can be totally internal to a combined RAM 824 and processor 814.

The connection 827 between the base system 800 and other devices, e.g., display assembly 900, can be implemented as a wired or wireless link. In the preferred embodiment, connection 827 is a wireless interface in the 915 MHz range. In one exemplary embodiment, connection 827 is used in a transmit-only mode, where data is only sent from the base system 800 to a display assembly 900 and where the display assembly 900 selects only a desired portion of the data, e.g., the data associated with a currently selected mode of the display 900. In a second option, connection 827 may be a bi-directional RF link, and use standard “WiFi” 2.4 or 5 GHz or even extended-range “Bluetooth”, “WiMax” or other newer RF schemes in-development. In those modes, programming new firmware into the base unit 800 or the display assembly 900 can be done through an optional conventional “router” which serves as the control point for the network these devices can be operated on. This could be managed from a local computer or done remotely over the Internet, if connected. Other wireless programming possibilities include mass distribution over the existing “pocket pager” frequencies, available for use throughout most of the USA, in a known manner. In fact, either pager or Internet services are capable of delivering other useful weather, grid status and even special control signals to the system herein disclosed. Future connectable products in-development, include hardware for low-priority local load-shedding or orderly shutdown of devices in brownout emergencies.

In another exemplary embodiment, connection 827 can be a driver or transceiver for a one-way or bi-directional hard-wired interface, such as that specified in EIA RS422, RS485 or Ethernet specifications, allowing long distance and reliable communication. Other connection schemes use wired 20 mA current loops as in industrial environments. It can be seen by one skilled in the art that any RF, optical multi-node, direct-wired, or even acoustic link could be utilized in a correct configuration and environment. As such, this is referred to as the communication interface, to cover all possible interfaces, possibly providing firmware upgrade or even additional data to the system. This additional data may be the current cost of the resource, provided by the seller, for use in calculations. It could also be the status of various related control systems or even the power grid, such as warnings of an impending brownout condition. It also could be other less-related data, such as weather, stock information, email notifications, or other information related to the needs of the user.

Because many new, highly integrated microprocessors provide various interface options, including sophisticated RF type interfaces, the communication interface 828 is shown as an integral part of the processor 814, as indicated by the dashed inclusion lines 815. Control lines 829 are to the communication interface, which could be either sent out of the processor 814 only for a transmit-only interface, or bi-directional in the case of a transceiver interface. Data lines 830 transport data between the processor 814 and the communication interface 828, which could be either data sent only out of the processor 814 for a transmit-only interface, or bi-directional data in the case of a transceiver interface.

Communication interface 828 is the data interface point primarily used for the sending of collected data to an antenna for RF applications, wire connections for wired operation, optical source, acoustic transponder, or any other connection to the network of displays, data sources and/or optional router. The dashed lines, surrounding the processor 814 and RAM 824, its program memory 818, multi-channel Analog-to-Digital converter 812, history storage unit 819 and communication interface 828 indicate optional inclusion of any or all of these parts into a single chip or chip-set, distributed in any manner. Integration of all of these functions is currently practiced in some cost or physical size-sensitive applications.

FIG. 9 is a block diagram of an exemplary display 900. Communication Interface 901 is primarily used for receiving data via data link 902 from base system 800, which could be an antenna for RF applications, wire connections for wired operation, optical transponder, acoustic or any other connection to the network of displays, data sources and/or optional router. Communication interface 901 provides communication over data link 902. In a preferred embodiment, communication interface 901 is a wireless interface in the 915 MHz range. In this case, it may be used in a receive-only mode wherein all possible displayed data is periodically transmitted by the base system 800, and the display 900 selects that portion of the data or “screen” information which the user locally selects.

In another exemplary embodiment, communication interface 901 may be a bi-directional RF link, and use the standard “WiFi” 2.4 or 5 GHz bandwidth or even an extended-range “Bluetooth” or other RF schemes. In those modes, programming new firmware can be done through a conventional (but optional) “router” which serves as the control point for the network the display 900 is operated on.

In another exemplary embodiment, communication interface 901 can be a driver or transceiver for either one-way or bi-directional communication using a hard-wired interface, such as that specified in EIA RS422, RS485 or Ethernet specifications, allowing long distance and reliable communication. Other schemes use wired 20 mA current loops as in industrial environments. It can be seen by one skilled in the art that any RF or optical multi-node, direct-wired, or even acoustic link could be utilized.

This additional data may be the current cost of the resource, provided by the seller, for use in calculations, status of various related control systems or even the power grid, such as warnings of an impending brownout condition. It also could be other less-related data, such as weather, stock information, email notifications, or other information related to the needs of the user. This data may be available via communication interface 901, or via an optional, additional communication interface, including all current and future types of communication interfaces.

Because many new, highly-integrated microprocessors provide various interface options, including sophisticated RF type interfaces, communication interface 901 is shown as an integral part of the processor 903, as indicated by the dashed inclusion lines 904. In the alternative, communication interface 901 may be one or more discrete components.

Control lines 905 connect the processor 903 to the link interface 901 in a known manner and can be either sent into the processor 903 only for a receive-only interface (not shown), or bi-directional in the case of a transceiver interface (as shown). Data I/O lines 906 connect the processor 903 to the communications interface 901 in a known manner and can be either sent into the processor 903 only for a receive-only interface (not shown), or bi-directional in the case of a transceiver interface (as shown).

Display processor 903 controls the reception and local processing of data for the display 914. Display processor 903 is a term used to cover a microprocessor, micro-controller, programmable gate array, programmable logic device, sequencer, or any electronic means for controlling the reception local processing of data for the display. In the exemplary embodiment of FIG. 9, some level of local data processing is possible including analysis, temporary storage, data reduction (for later use as historical data) and display calculation. In the preferred embodiment of FIG. 9, the received data need not be the entire bit-map of the display but instead can be either run-length or similarly encoded and compressed. Alternatively, it could merely be a sequence of graphical commands to create the display and be reduced to a few hundred bytes or less.

Display processor 903, at a minimum, needs only to perform the drawing operations. If an intelligent display is used, even that can be done outside of the display processor 903; display processor 903 is then reduced to merely a data manager for the display commands. In one exemplary embodiment, display processor 903 is in a slave-mode and selects the portion of the data stream containing the image of interest. During the rest of the time, it sleeps, drawing virtually no power. An ultra-low-power counter (not shown) times out to the next data packet of interest, and at that moment, the display processor 903 and its supporting components awake to receive new data and to send the new data to the display 914. If the display 914 is a cholesteric two-state, electronic ink or electronic paper display, current is drawn while the liquid crystals or colored dots form a new image, after which, power is reduced and the display 914 returns to sleep mode. Alternatively, with a normal active-matrix LCD requiring power for its own refresh, all or part of the display processor 903 and some or all of the peripheral electronics for display processor 903 may only go into sleep mode. It is therefore possible, with these disclosed transmission and control methods, to limit the receiver, processor, and/or possibly display power-on time to a very low period, enabling practical battery operation.

Storage unit 907 may be utilized for long-term, non-volatile storage of data to conserve power. In one exemplary embodiment, storage 907 is FLASH memory. Storage unit 907 may be implemented as a memory chip, memory chips, or a portion of the processor 903. Other options exist and will evolve for this element, but currently this is the most cost-effective option. In the disclosed exemplary embodiment, storage unit 907 is shown as an integral part of the processor 903, as indicated by the dashed inclusion lines 904. In an alternative embodiment, storage unit 907 is a discrete device.

Address and control lines 908 connect the processor 903 to the storage unit 907 in a known manner. Data I/O lines 909 connect the processor 903 to/from the storage unit 907 and can be separate, bi-directional, can be combined with the address and control lines 908 in serial or parallel data streams, or can be totally internal to a combined storage unit 907 and processor 903, as indicated by the dashed inclusion lines 904.

Program memory 910 stores the program code executed by processor 903. Address and control lines 911 connect the processor 903 to the program memory 910 in a known manner. Data I/O lines 912 connect the processor 903 to/from the program memory 910 and can be separate, bi-directional, can be combined with the control lines 911 in serial or parallel data streams, or can be totally internal to a combined program memory 911 and processor 903, as indicated by the dashed inclusion lines. Program memory 910 can be RAM, ROM, EPROM, FLASH, any other type of one-time programmable, re-programmable or random-access memory, or a combination of the foregoing. In one exemplary embodiment, a power backup mechanism is utilized in a known manner. In addition, conventional microprocessor systems store the program code in FLASH memory and, on power-up or re-boot, transfer the program code to RAM, e.g., RAM 913, where it can run at a faster RAM speed. Any of these and other schemes and all others practiced by those skilled in the art can be used. Data stored in the program memory 910 is usually only read by the processor 903, but also can be written during loading prior to shipment, allowing the latest revision of executable code to be shipped, or during subsequent field upgrades at a later date.

RAM 913 can be an element of the processor 903, as indicated by the dashed inclusion lines 904; alternatively, it can be external to the processor 903, or expanded externally. Working data and intermediate results of calculations are stored in RAM 913. In some implementations, data from numerous measurements can be temporarily stored in RAM 913 for a bulk data write to storage unit 907 at a convenient time.

Address and control lines 915 connect the processor 903 to the RAM 913 in a known manner. Data I/O lines 916 connect the processor 903 to/from the RAM 913 and can be separate, bi-directional, can be combined with the address and control lines 915 in serial or parallel data streams, or can be totally internal to a combined RAM 913 and processor 903.

Display 914 is the display portion of the display unit 900. There are a variety of technologies that can be employed in the display though certain technologies lend themselves to certain display applications. For instance, organic LED or OLED displays that self-emit light, have outstanding visibility, are small and have a wide viewing angle, and are therefore often preferable. At present, organic LED or OLED displays have a somewhat limited lifetime, so they are the best display for a bright switch-located display where power exists and the display only lights for a short period after activation of the switch, or any other on-demand display. For low cost implementations, LCDs are currently the best, but visibility of unlighted active matrix reflective types is relatively poor, except with high ambient lighting. Electronic ink, electronic paper or cholesteric displays only require power to change state and neither emits light nor easily adapts to backlighting, so they are limited to applications with ambient lighting. While light-emitting diodes or LEDs emit substantial light, they lack the resolution for all but the simplest displays, use substantial power and are expensive, so they are not as practical as other choices. Large displays, such as might be used for a device doing double-duty as an electronic picture frame, stock market or weather display, might be best implemented with a large, relatively inexpensive, back-lighted LCD, requiring the external AC power source 917 to drive a back-light incorporated into the assembly that includes display 914 and the supporting electronics. A desktop, cradle-mounted portable display could use any low-power, technology, only limited by the size of an included battery 920 and the time of intended portability of the device.

If WiFi wireless communications are employed in the disclosed energy conservation system, the currently-popular wireless personal audio devices incorporating an LCD screen, such as the iTouch™, manufactured by Apple Corporation of Cupertino Calif., or any other similar device can be used as the portable display, if loaded with a compatible software application. A data-service-enabled cell-phone with a display such as the iPhone™, also made by Apple, or similar device, used with the WiFi-enabled energy conservation system and a WiFi router connected to the Internet and the various 3G, 3Gs, 4G and other present and future cell phone data networks, can allow the same conservation display data to be displayed remotely, anywhere within the range of the phone, if loaded with a compatible software application. A phone connected in this manner enables remote monitoring of energy conservation in a rented vacation home or executive monitoring of power consumption in all or a critical part of a manufacturing facility. Remote monitoring of power consumption, generation and solar PV-driven battery charging at remote, unattended sites is easily implemented with the current system by those skilled in the art.

Since many integration-levels of these displays 914 exist, including serial and parallel interfaces, unintelligent to highly integrated microprocessor interfaced displays with drawing microcontrollers included, the choice of display is based on the product application, market and price target. The disclosed system is also applicable to future displays because the receiver processor can re-format data to the subject display, as may be required. Also, any portion of the other parts of this device may be integrated into an intelligent display hybrid assembly, as incorporating electronics on the back, or a flexible-circuit board attached to the display is a current manufacturing trend. These flexible assemblies allow folding the structure to fit an enclosure, or pack tightly in a small space.

Address and control lines 923 enable processor 903 to interface with display 914, including providing access to display memory (not shown) integrated in display 914. Data lines 920 may be separate from address and control lines 923 (as shown), and are often tri-state data lines used for the storing and, optional, retrieving of data from the display memory.

One or more processor I/O lines can interface to either a touch-screen, integral to the display assembly, or to discrete switches, e.g., switch 924. These elements control the display content and function and provide feedback to the data source, if included in the particular implementation. Other control options are possible. Switch 924 is a single mechanical pushbutton switch, although a plurality of switches may be used. Alternatively, switch 924 could be replaced with a capacitive switch, touch screen or even an optical or infrared sensor, so that function of the unit can be controlled by hand gestures in front of the display instead of by touch.

A bias resistor 925 connected to the local positive supply 918 can provide a logical high state bias to the processor I/O line when the switch 924 is open. Bias resistor 925 is often included and programmable within the processor 903. In addition, a ground or negative supply 926 connection provides an alternate logical low state to the processor I/O line 927 in the event the switch 924, or pushbutton, is actuated.

Power source 917 can be a wall-plug transformer which steps the available voltage down to a level usable by the power supply 918 and is connected to a nearby line voltage AC power outlet. Alternatively, or in cooperation with the AC supply, a set of replaceable primary or rechargeable batteries 920 or super-capacitor, can power the unit when the display unit 900 is designed to be removable from its base or cradle, which includes a connection to the charging source. Instead, and perhaps preferably in some embodiments, this power source can employ an “energy-scavenging” scheme, if the power required is low enough. Energy-scavenging is a relatively new term, referring to collecting small amounts of power from the device's environment. Scavenging methods can include special solar cells chemically-doped for indoor light spectral sensitivity, seismic piezoelectric or Faraday-type generators, resonant electromagnetic collection and even conceivably thermoelectric generators if used in an area with thermal differentials or cycling, etc. If a display and most of the associated electronics sleep between updates, and the periodic power requirement is low enough, the average power required by display 900 could enable the use of these energy-scavenging sources, eliminating wires and/or battery replacement. Since the critical refresh data in this embodiment of display 900 can be kept in the base unit 800, a temporary loss of power would only result in a loss of display updates until re-charge occurs. Thus, in some embodiments where a power connection is inconvenient, and primary batteries a nuisance, power scavenging may be the preferred power source.

Power supply 918 provides the power conversion, if needed, from the service provided by the power source 917 to stabilized DC voltages for running the electronics and charging the battery 920 or other energy-storage means that might be included. Battery 920 may be a primary battery or solar battery, without a need for the power supply 918, input connection 919, power source 917, secondary battery, super-capacitor or any other energy storage means. A rechargeable means is ideal for a charging-cradle-mounted unit as it affords portability to the display 900 for investigating various individual loads within reach of a communication interface 901. For example, portable displays can be carried about in the search and quantification of individual power loads of concern, such as the so-called “vampire loads”, i.e., loads from devices in, for example, a stand-by mode, common in modern electronics. These hidden loads occur in devices when supposedly powered off, and can be as high as 20 watts for a cable converter box, for example. To identify offending devices throughout a facility, a small wireless portable display can display the current energy usage vs. historical energy usage used in a linear, non-accumulating manner on a shortened time scale. A scale as short as a few seconds might be useful, but one or more minutes may be more practical in this application, and user adjustable scales are possible. The entire scale changes gain and vertical offset so that both its peaks and dips are visible on the screen to expand the scale substantially. In this manner, the system is sensitive enough to measure a leakage or “vampire” load, such as occurs from a turned off stereo or other home appliances (e.g., appliances in standby mode), by disconnect, even when measured with a hundred amp base-load on the system.

Terminals 921 and 922 provide the DC power for display 914 and its supporting electronics.

The dashed lines 904, surrounding the processor 903 and RAM 913, program memory 910, storage unit 907 and communication interface 901 indicate the optional inclusion of any or all of these parts into a single chip or chip-set, split in any manner. Integration of all of these functions is currently practiced in some cost or physical size-sensitive applications.

FIG. 10 is a block diagram illustrating an integrated implementation of a combined base system 800 and display system 900. Integrated display 1000 monitors and displays energy usage and conservation on a single AC power phase. Integrated display 1000 can perform that function or, through an electromechanical or electronic means, can additionally switch or vary the current passing through the AC Line conductor, and thereby control a connected load. Combining the sensor and display portions of the exemplary embodiments, as disclosed in FIGS. 8 and 9, respectively, causes several components to be redundant. The resulting lower-complexity device is shown in FIG. 7 and diagrammed in FIG. 10, for local energy usage and conservation monitoring. With all-in-one processors containing Analog-to-Digital converters, RAM, FLASH, and Program Memory, interfaces to the outside world, and a display, a very high level of product integration is now possible. This allows integration of an exemplary embodiment of the invention, complete with a display, directly into a switch assembly for consumer and industrial installation. Other than turning off the circuit breaker for the affected circuit for safe installation, access to the inside of the power panel is not required in this implementation.

Since the function of the elements of FIG. 10 have been discussed in detail in conjunction with FIGS. 8 and 9, the following discussion will only mention the major or unusual features in the exemplary embodiment of FIG. 10.

AC Line 1001 (the “Hot” terminal) is at line voltage relative to the AC Neutral Line 1002 and protective Ground Line 1003. In North America, this is nominally 120 VAC for home lighting circuits, 277 VAC for industrial lighting and up to about 240 VAC for foreign applications.

It is important to note that, although the input and output terminal arrangement would be different for most foreign applications as both ungrounded terminals AC Line 1001 and AC Neutral 1002 are considered “hot” and are at potentials above ground, the disclosed system can operate in this environment. The sensing circuit for current and voltage is still valid for a single-phase circuit. Only the AC power connection terminology and physical hardware, as well as the voltage and currents sensed, would vary by country.

AC Neutral Line 1002 is connected to a common neutral bus at the service circuit breaker panel and is the return wire for current to a circuit powered by AC Line conductor 1001. Ground line 1003 is an optional AC protective ground terminal or ground wire. Only circuit leakage or fault currents flow in protective grounds. Grounding should be connected in multiple places, if possible, to assure safety.

Ground screw terminal 1003 represents an actual screw terminal or a wire for use, if needed, when a ground conductor is included in the wiring, or if the device is mounted in a non-metallic box. Another possible ground connection is made through the mounting screws 1004 in the metal frame of the device to a metallic switch box. Ground screw 1003 and frame screw 1004 are interconnected through the device frame.

Ground connection 1007 is a local protective ground connection to the device metal parts, which connect to the electrical box on installation and constitute any metal enclosure parts and the frame on which the device is constructed.

Resistor 1005 is the line resistor in a line voltage divider network and resistor 1006 is the neutral side resistor of the line voltage divider network; together these two resistors create, from the line voltage, an accurate fractional representation for digitization in the multi-channel Analog-to-Digital converter 1013.

Current transformer 1008, through which the AC line circuit passes on its way through the device, measures all currents passing through the current transformer, including those to the local DC power supply 1009 for display assembly 1000. If this is undesirable, conductor 1010 can bypass the current transformer 1008 and connect at terminal 1001 instead.

Resistor 1011 is the burden or load resistor for the current transformer 1008 and the value of it is selected to create a low voltage with an accurate relationship to the current flowing through the transformer 1008 for digitization in the multi-channel Analog-to-Digital converter 1013.

OVP protection networks 1012 are voltage spike-limiting back-to-back zener diodes, metal oxide varistors or other similar energy-limiting devices, which limit line voltages and lightning-induced voltage spikes to protect the multi-channel Analog-to-Digital converter 1013. Note that there are limits to exactly the magnitude and duration of voltage spikes that a network of this type can protect against. The limits may typically be two times the rated operating voltage for a specified short period of time, or rated in Joules of energy absorbed before protection failure.

AC to DC power supply 1009 provides the DC voltages required by the circuitry of integrated display assembly 1000, including the display 1014 and any optional electronic load switching. AC to DC power supply 1009 includes a long-life lithium cell or super-capacitor (not shown but described in earlier embodiments) to manage power-down and brown-out situations appropriately without losing data already in memory, if the loss of power is of sufficiently short duration.

In the integrated display assembly 1000, the multi-channel Analog-to-Digital converter 1013 is likely part of the processor 1015 as a high level of integration is desirable. The term “processor” is a term used to cover a microprocessor, micro-controller, programmable gate array, programmable logic device, sequencer, or any electronic means for controlling the sequencing of data collection, local processing and in this case, driving the display or its interface. In this exemplary embodiment, all local processing is done including high-speed data sampling in the multi-channel Analog-to-Digital converter 1013 to accommodate current waveform distortion and accurate RMS conversion, data analysis, and temporary storage in the on-board RAM 1016 or storage unit 1017. A program stored in the on-board program memory 1018 controls the process and reduces and stores data in storage unit 1017 for later use as historical data.

Ultimately, the display content is calculated from current and historical data. If a display 1014 is intelligent, drawing graphics can be done outside of the processor and in the display; otherwise, the processor may have to do the drawing and even the display refresh. Because power is locally available, there is less concern over power used, and the processor does not have to shut down, though if not calculating, this is still useful to do. If the display 1014 is a cholesteric two-state, an electronic ink or electronic paper display, current is drawn while the liquid crystals or colored dots form a new image, after which, power is cut and the display unit 1014 returns to sleep. Alternatively, with a typical active-matrix LCD requiring power for its own refresh, all or part of the processor and some or all of its peripheral electronics may only periodically go into sleep mode.

Optionally, program memory 1018 may be contained on a removable FLASH or ROM card for upgrading in the future. Integrated display assembly 1000 may also include a communication interface (not shown but described in earlier embodiments) for upgrading the program memory in-place in a known manner.

Storage unit 1017 is preferably included in processor 1015 and is used primarily for long-term data accumulation; it can also be used to store a few frames of display information or the commands to create them and other relevant display and control data.

Low-power display 1014 preferably only uses a small amount of power in order that only a small local power supply is required. While an inexpensive LCD would work in this unit, a self-emitting OLED, or essentially zero-power cholesteric LCD, electronic ink or electronic paper display, lends itself to the packaging requirements. All three display examples are potentially thin and even flexible for incorporation behind a clear or contrast-enhancing tinted polycarbonate window.

Touch-screen connections to the processor electronically indicate any areas of the screen touched or stroked, in order to invoke various conservation displays, diagnostic modes or even connected circuit control. The input AC Line current connection 1001, which supplies current to be monitored, can optionally be controlled by the symbolic switching means 1019 (or substituted dimmer circuit known to those experienced in the art) to an AC load connected to 1020. The AC Neutral current return conductor connects to 1021. The protective ground, which enters the metal switch-frame, is connected to the wall mounted electrical box through the mounting screws connected to GND terminal 1003. In the case of a non-metallic box, the ground connection must be made through the ground wire or ground wire screw 1004.

There can be, as implemented in the split system depicted in FIGS. 8 and 9, an optional communications interface (not shown) in the stand alone display unit 1000 of FIG. 10, for programming upgrades and interface to other optional data sources for use in calculating the various displays, such as power company rate information, or other pertinent data, such as weather or degree-days information received, for example, from the internet. Email notifications or other non-related notifications can be incorporated as well, expanding the typical wall switch operation to a multi-function datacenter.

It should also be obvious to anyone skilled in the art that a two-phase embodiment of the block diagram in FIG. 10 would only require adding an additional AC Hot conductor 1001 and 1020, another current transformer 1008 and burden resistor 1011, an added resistor divider 1005 and 1006 and an additional pole in the optional switch 1019. The OVP circuit 1012 and multichannel A to D converter 1013 would become quad-differential channel devices. This embodiment could monitor a branch circuit to an apartment, a high-power appliance such as an electric clothes dryer or the charging station for an electric vehicle.

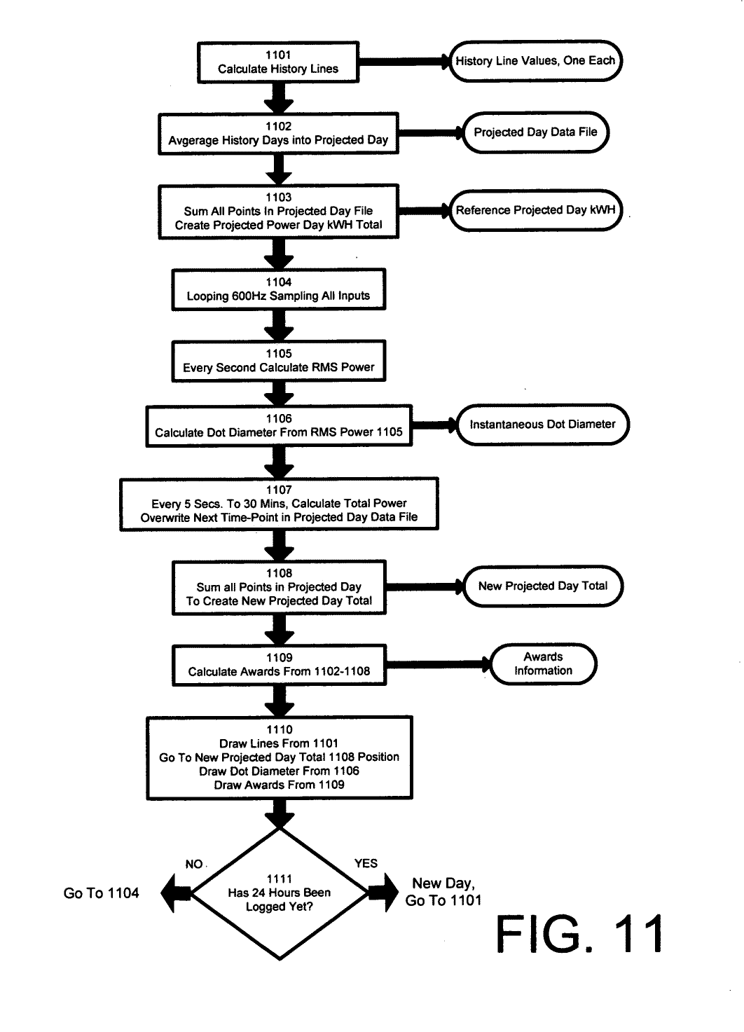

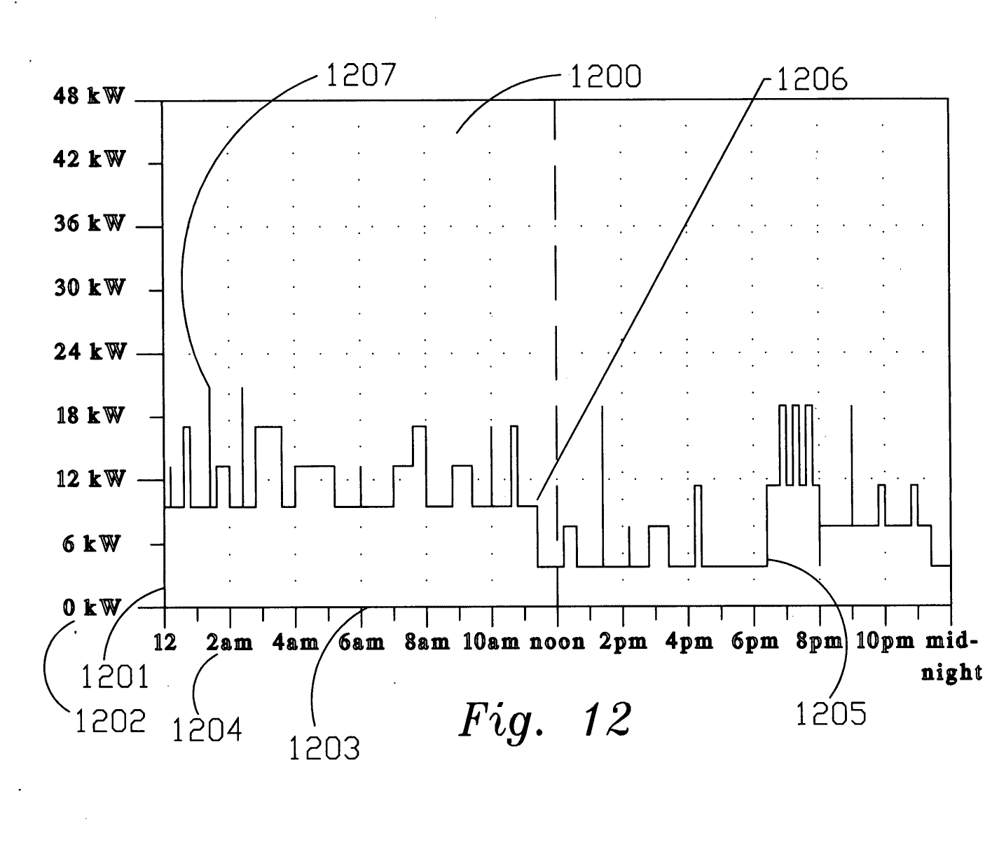

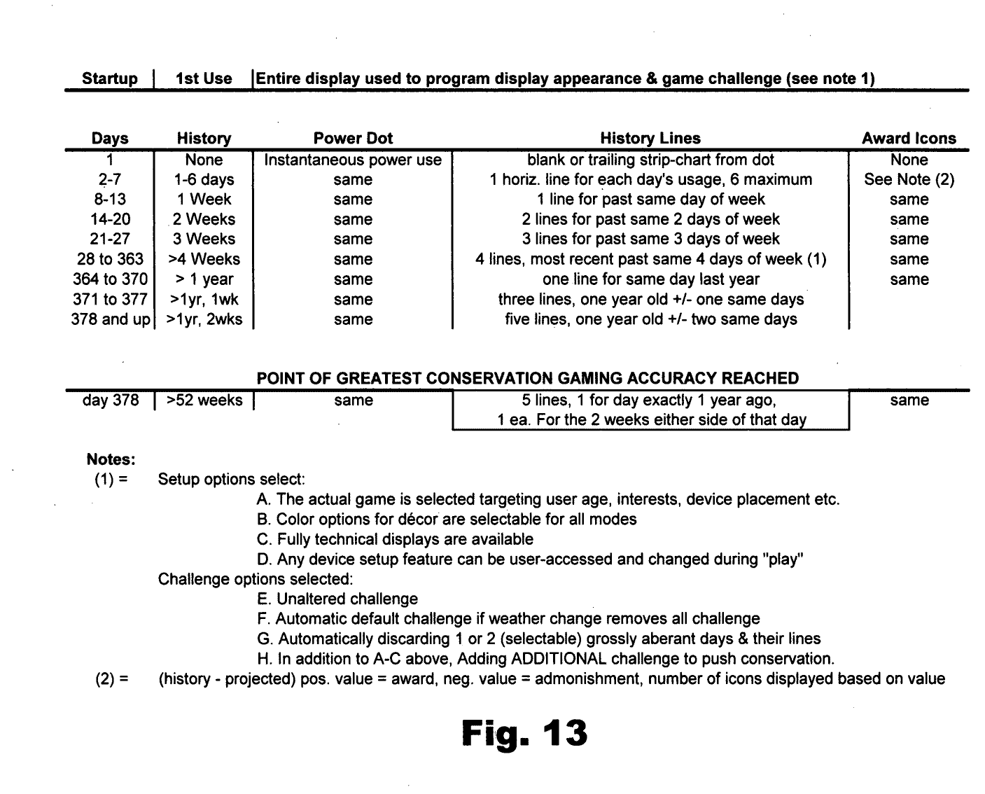

FIG. 11 is a flowchart illustrating a method for monitoring and displaying energy usage in an eco-gaming environment. During step 1101, executed just after midnight in the preferred embodiment, the location of each of the N horizontal history lines are determined by computing the total energy consumed for each of the “N” selected previous days, that correspond to the same day of the week as the present day of the week, where “N” equals the number of history days used. (In the alternative, data from N other days may be used, e.g., 1) N other days of the same season; 2) N other days of the same season from one or more previous years; 3) N other days of the same season from one or more previous years that correspond to the same day of the week as the present day; etc.) The values are computed from previously stored data (as described below in conjunction with the table of FIG. 13) and are saved for repeated use, for example, for redrawing the history lines on the display during the following 24 hours. The vertical location of each horizontal line is then identified by normalizing the value computed in step 1101 to the range of values represented by the face of the display using well known techniques.

During step 1102, each of n samples, where “n” equals the number of samples within a day's history file, from within each of N history data files, where each history data file corresponds to one of the N days represented by a horizontal line, corresponds to substantially the same exact time of day. Each of the n samples corresponding to the same time of day in each day file, are added together and divided by “N”, creating a new set of n samples for a new “projected day” data file. If each of the original days of the N history days contained n samples, then the resulting “projected day” data file would similarly contain n averaged samples. (The actual number of samples in a day's history file is a function of the type of data compression selected, and does not affect the basic operation of the device, but only the time resolution of the display.) The sum total of the n samples contained in the “projected day” history data file is then calculated 1103 and the resulting value is used during the next 24 hours as the reference projected power value, typically in kWH, and the value is used in calculating display reward or admonishment for the next 24 hours.

During the looping step 1104, the output of multi-channel analog-to-digital converter such as 812 or 1013, is read and stored repeatedly, once for each of its inputs, (e.g., each voltage and current measurement for each phase) building a measurement set for each input. After a predetermined period, the RMS value of each set of samples is calculated thereby providing measurements that are proportional to the current and voltage in each phase being monitored. The calculated RMS values are stored in working memory. For example, a sample rate of 600 Hz may be used for each input to accommodate the power line waveform distortion commonly experienced when loads of very poor power factor are prevalent.

During step 1105, the energy for each monitored phase is calculated and the results are added together periodically (perhaps once per second or slower, if desired).

Next, in step 1106, the diameter of dot 206 is calculated by multiplying the size of the largest possible dot (a design choice) by the ratio of the current energy being consumed to the capacity of the system being monitored or a non-linear representation thereof. This value is used to draw the dot diameter which is centered at a location spaced from the baseline of the display by the projected power consumption for the day.

In step 1107, the energy for each monitored phase is calculated and the results are added together. The resulting value is stored in the memory location corresponding to the current time of the current day within the “projected day” data file (replacing the corresponding values at a rate, for instance, of from once per 5 seconds to once per 30 minutes). The sampling rate depends on the history compression desired.

In step 1108, the sum of all the samples in the “projected day” data file is calculated, providing a new projected day total for use in plotting the vertical position of the dot whose diameter was calculated in step 1106.

In step 1109, an award or admonishment amount is then calculated by subtracting the new projected day total 1108, from the reference projected day total value 1102 and computing the percentage change and direction using known methods. The number, type and placement of award or admonishment icons are then determined based on the percentage of conservation or waste of the resource.

In step 1110, the horizontal lines are drawn at the positions calculated in step 1101, and the dot whose diameter was calculated in step 1106 is plotted at a vertical position calculated in step 1108. Finally, in step 1109, the award or admonishment icons from step 1108 are drawn.

A test is then performed during step 1111 to determine if 24 hours has passed since step 1101 was executed. If 24 hours has passed, step 1101 is executed; if 24 hours has not passed, step 1104 is executed.

FIG. 13 is a table (Table 1 hereinafter) describing an exemplary method for selecting days of historical data that are of relevance to the current day for use in evaluating conservation effectiveness. The selection is based on the number of days on which data has been collected. Table 1 illustrates the data used in the calculations for an exemplary embodiment of the method of FIG. 11. As noted in Table 1, no history data is available during day one (the first day of use). The history lines cannot be calculated as there is no data for previous days; however, a blank or trailing strip-chart emanating from the dot 206 may be displayed. Similarly, no award icons may be displayed since no improvement in conservation has been recorded. The power dot 206 indicates the instantaneous power usage.

Beginning on day two, and from this day forward, the pertinent past history day or days, as defined in Table 1, are used to create history line values 1101 and are averaged to create a projected day's usage 1102, and used for the remaining steps of FIG. 11. It can be seen in the current embodiment that choices are made to select the most relevant data and as history accumulates, increase the validity of the comparison and award or admonishment.

During days two to seven, one to six days worth of historical data is available; therefore, a horizontal line may be determined and displayed and averaged 1102 to create the projected day. The award icons are determined according to step 1109 (as described above).

During days 8-13, a minimum of one week's worth of historical data is available; therefore, a single horizontal line should be determined and displayed and used to create the projected day. The award icons are determined according to step 1109 (as described above).

During days 14-20, a minimum of two week's worth of historical data is available; therefore, two horizontal lines should be determined and displayed and averaged 1102 to create the projected day. The award icons are determined according to step 1109 (as described above).

During days 21-27, a minimum of three week's worth of historical data is available; therefore, three horizontal lines should be determined and displayed and averaged 1102 to create the projected day. The award icons are determined according to step 1109 (as described above).

During days 28-363, a minimum of four week's worth of historical data is available; therefore, four horizontal lines should be determined and displayed and averaged 1102 to create the projected day. The award icons are determined according to step 1109 (as described above).

Starting on day 364, a minimum of 52 weeks worth of historical data is available, therefore the exact same day of the year has become available for comparison. At this point in time, a single line for that day's total is displayed and used to create the projected day. The award icons are determined according to step 1109 (as described above).

Once 371 days worth of historical data is accumulated, the year-ago day and the same day one week before and one week after are displayed and averaged 1102 to create the projected day. The award icons are determined according to step 1109 (as described above).

After day 378, a minimum of 54 week's worth of historical data is available. At this point, the same day of the week exactly 52 weeks earlier and the same days of the week from the two weeks prior to and following that year-ago day are displayed and averaged 1102. Thus, five horizontal lines are determined and displayed. It should be noted that the averaging of several days of the most significant, similar and relevant data available at any given time, is key to the function of the approach in Table 1. It critical to the process that any aberrant days are reduced in impact, so that the game is maintained as an effective challenge. Selective averaging is one method of achieving this end result. Influences such as weather or a significant change in occupant habits can cause one or more days to be substantially different than expected. In that event, a voting step, not shown, with pre-defined percentage of difference limits, could discard those days resulting from a power outage, vacation, or extreme weather.

Not detailed in the chart are the options available after a second year of data collection has passed. With multiple years to draw upon, the choice includes just displaying the two or more same dates of the year and competing against their average, only displaying the more-difficult of the same past dates, or if both are too easy, creating a greater challenge, related to those days.

FIG. 12 is a Cartesian graphical representation of the numerical values stored in a portion of linear memory, e.g., storage unit 819 or 1017. This memory portion is of sufficient size to contain all measurements for a period to be evaluated. While other periods can be used, the preferred embodiment uses a period of 24 hours, beginning at 12:00.001AM to 11:59.999PM, or one full day. In FIG. 12, the chart 1200 is a depiction of numerical values on the y axis for power consumed 1201. Shown is a calibration relating to the capacity of the system being monitored. In the example of FIG. 12, the range of numeric values 1202 is zero to 48 kilowatts, which is the limit of a common home-type electrical service circuit breaker panel which is rated at 240 VAC and 200 Amps. This range can be adapted to any value for other applications.

FIG. 12 also has an x axis 1203 representing time. In the example of FIG. 12, a day's data is shown that is pre-calculated from the methods described earlier or using similar history-averaging means, using data from one or more earlier related dates that is averaged. Time progresses from left to right, as is typical for charts of this type. The x axis 1203 is calibrated in hours 1204 over the 24-hour midnight to midnight period. The resolution of the memory and the resulting product can range from milliseconds to hours. While the display can briefly be halted as history data 1205 are calculated and the memory is filled, other transparent methods may be used. Instead of disturbing the display process, calculations can be done in parts, during the 24 hours before it is needed or at a time when the processor is idle. Calculation of history lines 1101 and summation of the individual data points of those days just after the midnight, creates the projected day's data, to over-write yesterday's projected data at precisely 12:01.001. This must be completed before any new day's data was over-written, as was described earlier in FIG. 11-1107 and is subsequently used for display in the following steps.

For the example given in FIG. 12, today's data has already been written over the history stored in memory, to a time of about 11:20AM 1206. Note that the new data for today 1207 has a higher baseline, relative to the history data to the right of 11:20AM 1206. Assuming the over-written history data was roughly in-line with the data shown after 11:20am 1206, then the current day will use more power than was projected by the average historical day. This information is subsequently used to provide a graphical admonition, in this case, on the user display, or used in many other graphical or numeric ways to document the user's increase in energy usage, carbon footprint and other relevant statistics.

Instead, if the new data for today had provided a reduction when compared to the stored averaged history data, the graph on the left side leading up to the 11:20am current time would have a lower consumption total for the period over-written in memory, and demonstrate some level of energy conservation. This, compared to an estimated daily total taken just after midnight, would provide a lower estimate for the new day as the day proceeds. This is an important feature as highly interactive feedback is given to the user during the course of the day, allowing corrective actions to be taken in the quest for a better reward on the user display. For instance, if the utility employs “time of use metering” that charges less for off-peak usage and nighttime power, and this is incorporated into the calculations, shifting power-intensive activities to lower-cost periods could be very effective at offsetting a day that is projected to be worse than normal. Other changes in optional energy usage, such as not using the sauna or whirlpool bath today or reducing the use of air-conditioning, exemplify some of the additional manners of offsetting the energy waste earlier in the day. It is proposed that the continued use of the system will increase awareness of energy-intensive activities and promote overall resource use reduction through the game, into which the users are drawn by the animated graphics-based conservation game. Other sources of incentive include peer-pressure through knowing others can see the results of your behavior and the positive feedback of a reduced resource bill at the end of the month. It is a known fact by those versed in the field of behavior modification, that people modify behavior based on three primary influences: fear (of waste in this case), peer pressure (from others seeing your behavior) and reward (in this case, cost savings). All of these are satisfied by the current invention and actively encourage conservation.

It is easily seen by anyone skilled in the art that alternative versions of the present conservation display can be constructed for other applications. Such applications include dimming, timing or remote control for single or two-phase AC voltages, using the circuitry described herein with only minor additions or modifications.

Larger displays can be integrated into wall-mounted picture frames, normally displaying random photos and changing on touch or nearby human presence to a power monitoring display. This display might allow access to local weather from connected outdoor instruments or data from a weather service such as AccuWeather™, The Weather Channel™ or the National Weather Service/NOAA. The displays may also be incorporated into major energy consuming appliances, such as refrigerators. These appliances already are marketed with small televisions or dedicated weather displays, such as those in high-end models from LG, Inc.™.

In addition to the display of energy consumption and energy conservation performance, the system can include other features, including an ambient light sensor or clock function that can turn off the display or its backlight to conserve power. An infrared or any type of motion sensor can detect an observer by their proximity, their touch or even hand-gestures to control actions such as mode switching. In one exemplary embodiment, the display operates as an electronic picture frame; a consumer version can switch from displaying random pictures from memory to showing the energy usage with a touch or a wave of a hand. It can then sense a change indication again, and show the weather forecast. If a mode switch is not requested after an adjustable period of time (15 seconds nominal), the display will revert to displaying the picture(s) again.

The display may display weather information including current time of day, the weather for today plus some number of following days, the current temperature, current wind speed and direction, air quality, UV index, the expected high and low temperature for each day (numerical values) and weather alerts (graphics or text).

A table-top version of the display system shown schematically in FIG. 9 with the small display replaced with video driver circuitry or a suitable digital interface could drive a large plasma, LCD or video projector in a corporate boardroom or lobby, demonstrating how “green” the company really is.

Other Displays

Two display types have been discussed in detail in the above, and the option of creating your own display from a library of shapes and movements was discussed. In a preferred embodiment, the data and history processing are substantially implemented in one software process and the display portion of the software is mostly implemented in another, called the graphical user interface, and abbreviated as the “GUI”. These two software processes are connected by the data passed to the display (and from it, if there is a user-interface such as a touch screen), and the graphical visual interface can be quite different for varied installations. For instance, in the case of children, a boy's room display could take on the nature of a baseball game with the home team scoring runs based on conservation success. For a girl's room display, the display can produce animated butterflies when the trend is good or feature age-appropriate images of their favorite TV characters, stars or band-members (all licensed, from their sources), possibly from some portion of the devices memory. Connecting to the web or a local network allows for obtaining images and animations from a remote location or creating competitive play between friends or family members. An included light sensor or timer function can dim the display at night for a night-light effect.

As for more adult applications, alternate displays such as stock market, weather (including flashing severe weather warnings), news, email, electronic picture frame, blanking, solid décor-matching or accentuating color, indoor temperature, solar PV or thermal energy production or banking graphics or just random attractive animations are some of the endless options. On a network, it could also connect to a remote front-door, outdoor or other remote security video camera, providing that display only as required or on motion sensing.

The concept described is intended to use the most effective graphical display methods possible to capture the target audience and to motivate them to continually reduce their waste of a valuable resource. Various means are provided such that the analysis software and graphical methods can be upgraded over the life of the product, to prevent boredom or increase effectiveness as the psychology of the attention capture and user motivation process is better understood.

Other Applications

In addition to AC Power, as has been thoroughly discussed in conjunction with FIGS. 8, 9 and 10, flow meters monitoring water, gas or any other consumable resource may be utilized. A similar product can be constructed wherein the same “gaming against past consumption” mechanism can effectively encourage gradually reducing consumption.

While it is very difficult, if not impossible, to gauge daily consumption habits through a bill that arrives monthly, or in the case of water, possibly quarterly, it is proposed that the current invention resolves this problem. Through monitoring and reporting how much is consumed against the recorded past history, relevant feedback is given in an analog fashion. There is no need to imagine what a kilowatt-hour of electricity, or gallon of oil, or cubic foot of water or therm of gas is. Nor is it necessary to mentally compare these numbers to history that may not be remembered. More importantly, this mechanism adapts to the user, immediately on installation providing useful guidance possibly as often as every second, more accurately within a week of installation, and reaching substantially full accuracy in approximately one year. Payback is continual and compounds itself, as long as the “conservation game” is played, as this year's reduction is added on top of previous year's. Through an unimposing, perhaps entertaining process of gradually reducing your consumption, a user may be trained to require less of the valuable consumable resource. Reducing energy needs can subsequently result in, for instance, saving by requiring a smaller solar photovoltaic system in the future that is capable of satisfying a user's reduced needs. Similarly, with heating fuel, costs will be controlled or reduced and, with water consumption, a drought-reduced resource may still adequately serve a user's needs.

This system can also be adapted to using current cost data, when it becomes available over the Internet or some other mechanism from the provider. It is proposed that, because of the varying costs, the price paid this month may not be directly comparable to that paid last month, or last year, and therefore, the important link to actual use may be lost if this relationship is not accounted for. Since the overriding goal is the conservation of the measured consumable, this system provides feedback, which is directly relevant and properly guides conservation.

It is to be understood that exemplary embodiments and variations have been shown and described herein and that various changes, modifications, or alterations within the scope and spirit of the invention may be implemented by those skilled in the art.

We claim:

1. A method for monitoring usage of a consumable resource, comprising the steps of:
obtaining measurements of usage of said consumable resource;
determining a first graphical representation to represent said measurements of consumable resource usage, wherein said first graphical representation comprises a symbol that represents an average of one or more measurements of consumable resource usage; and
displaying said first graphical representation.

2. The method of claim 1, further comprising the step of computing a projected usage of said consumable resource for a specified time period based on said obtained measurement

3. The method of claim 1, further comprising the step of obtaining a substantially instantaneous measurement of said consumable resource usage;
determining a second graphical representation to represent said substantially instantaneous measurement, wherein a size of said second graphical representation is proportional to said substantially instantaneous measurement; and
displaying said second graphical representation.

4. The method of claim 3, further comprising a step of computing a projected usage of said consumable resource for a specified time period based on said obtained measurements and wherein a display location of said second graphical representation represents said projected usage.

5. The method of claim 1, wherein a color of at least one of said first graphical representation and a second graphical representation represents an associated measurement.

6. The method of claim 1, wherein a shape of at least one of said first graphical representation and a second graphical representation represents an associated measurement.

7. The method of claim 1, wherein a quantity of symbols utilized in said first graphical representation represents an associated measurement.

8. The method of claim 1, wherein said first graphical representation comprises one or more of a symbol, an object, an image, a motion of a symbol, a motion of an object, a motion of an image, and an interrelationship between two or more of an object, an image, and a symbol.

9. The method of claim 1, further comprising the step of determining a level of conservation of said consumable resource using one or more of said measurements of usage of said consumable resource.

10. The method of claim 9, wherein a state of a game is based on said level of conservation

11. The method of claim 10, wherein said game is one of a baseball game, a football game, a hockey game, a soccer game, a board game, and a card game.

12. The method of claim 11, wherein one or more images are used to represent said state of said game.

13. The method of claim 10, wherein said level of conservation is based on a difficulty factor selectable by a user.

14. The method of claim 1, further comprising the step of displaying weather-related information.

15. The method of claim 1, wherein said measurements of consumable resource usage are adjusted to compensate for a variable cost of said energy, wherein said variable cost is based on a time of day.

16. The method of claim 1, wherein said consumable resource is one of electricity, water, oil, natural gas, bio-gas, methane, gasoline, and propane.

17. A method for monitoring usage of a consumable resource, comprising the steps of:
obtaining a first measurement of usage of said consumable resource;
changing a consumption level of a device;
obtaining a second measurement of usage of said consumable resource; and
displaying an indication of a difference between said first measurement of usage and said second measurement of usage.

18. The method of 17, wherein a scale of said displayed indication is adjusted based on said first measurement and said second measurement to emphasize said difference.

19. An integrated energy conservation and control device comprising:
a memory; and
at least one processor coupled to the memory and operative to:
obtain measurements of usage of said consumable resource;
determine a first graphical representation to represent said measurements of consumable resource usage, wherein said first graphical representation comprises a symbol that represents an average of one or more measurements of consumable resource usage; and
control a consumption of a resource in one or more devices.

20. An energy conservation device, comprising:
a memory; and
at least one processor, coupled to the memory, operative to:
obtain measurements of usage of said consumable resource;
determine a first graphical representation to represent said measurements of consumable resource usage, wherein said first graphical representation comprises a symbol that represents an average of one or more measurements of consumable resource usage; and
display said first graphical representation.

21. An energy conservation device, comprising:
a memory; and
at least one processor, coupled to the memory, operative to:
obtain a first measurement of usage of said consumable resource;
change a consumption level of a device;
obtain a second measurement of usage of said consumable resource; and
display an indication of a difference between said first measurement of usage and said second measurement of usage.
